(19) United States
(12) Patent Application Publication
(10) Pub. No.: US 2008/0043038 A1
(43) Pub. Date: Feb. 21, 2008

(54) Systems and methods for incorporating three-dimensional objects into real-time video feeds

(76) Inventor: Jacques P. Frydman, Sao Paulo (BR)

Correspondence Address: KALIKO & YEAGER, L.L.C., 500 NORTH FRANKLIN TURNPIKE, RAMSEY, NJ, 07446, US

(21) Appl. No.: 11/506,115

(22) Filed: Aug. 16, 2006

(51) Int. Cl. G09G 5/00

(52) U.S. Cl. 345/632

(57) ABSTRACT

Devices, systems and methods for incorporating three-dimensional objects into a real-time video feed are disclosed. The exemplary method may transmit a first video signal of a live event to a processing means and receive the first video signal at the processing means. One or more predefined three-dimensional objects are generated on the processing means by programming a commercially available software game engine. One or more predefined three-dimensional objects are processed. The one or more predefined three-dimensional objects are altered dynamically and controlled using one or more of 1) real-time inputs from one or more users, 2) artificial intelligence, 3) the laws of physics, and/or real-time inputs from one or more users and artificial intelligence. The one or more processed three-dimensional objects are stored to a memory device. The contents of the memory device are converted into a second video signal. The first video signal and the second video signal are merged using at least one of an alphakey, a chromakey, and a lumakey generator device to create a third video signal. The third video signal is broadcast to the user's viewing device.

### CROSS REFERENCE TO RELATED APPLICATIONS

This application is related to U.S. Provisional Patent Application No. 60/708,545 filed Aug. 16, 2005 entitled SYSTEMS AND METHODS FOR INCORPORATING THREE-DIMENSIONAL OBJECTS INTO REAL-TIME VIDEO FEEDS, which is incorporated fully herein by reference.

### FIELD OF THE INVENTION

The present invention relates generally to video systems, and more particularly to a video system for incorporating three-dimensional computer generated images.

### BACKGROUND OF THE INVENTION

Computer graphics hardware for television allows a user to mix computer graphics with a live feed, but the results are fixed and predetermined, such as a football broadcast's use of a first-down indicator and a play illustrator. Previously, some hardware/software combinations have made real-time “rendering” possible; however, these combinations have significant limitations in that they only allow real-time or near real-time updates of textual data or of very simple animations with no user interactivity and the costs of such implementations are extremely high.

Accordingly, an efficient and effective system and method is needed for providing real-time or near real-time updates of three-dimensional computer generated images into a video signal.

### SUMMARY OF THE INVENTION

It is, therefore, an objective of the present invention to provide devices, systems, and methods that incorporate three-dimensional objects into a real-time video feed.

According to an exemplary embodiment of the present invention, a system has a camera for capturing the live event and creating a first video signal, a transmitter for transmitting the first video signal, and a processing means for receiving the first video signal. A commercially available customizable software game engine located on the processing means generates one or more predefined three-dimensional objects. The one or more predefined three-dimensional objects are altered dynamically and controlled using one or more of 1) real-time inputs from one or more users, 2) artificial intelligence, 3) the laws of physics, and/or 4) real-time inputs from one or more users and artificial intelligence. A memory device located on the processing means is capable of storing one or more predefined three-dimensional objects. A converter creates a second video signal that includes the contents of the memory device. The system may have a merging means for merging the first video signal and the second video signal and creating a third video signal. Finally, a transmitter broadcasts the third video signal.

In an additional aspect of the invention, the method may also include a matching means for dynamically matching a perspective of one or more predefined three-dimensional objects to a perspective of the first video signal using sensor data generated at the live event, and/or a combination of software and hardware to perform image/pattern recognition on the processing means.

### BRIEF DESCRIPTION OF THE DRAWINGS

The above and other objectives and advantages of the present invention will be apparent upon consideration of the following detailed description, taken in conjunction with the accompanying drawings, in which like reference numbers refer to like parts throughout, and in which:

FIG. 1 shows a generalized schematic of an exemplary video system used to implement a preferred embodiment of the present invention.

FIG. 2 is a flow chart illustrating a first exemplary embodiment of the present invention.

FIG. 3 is a flow chart illustrating a second exemplary embodiment of the present invention.

### DETAILED DESCRIPTION OF THE INVENTION

One embodiment of the present invention allows for an infinite live user interaction where real-world physics and artificial intelligence can be applied to any three-dimensional object or character in real-time or near real-time, allowing for real-time or near real-time rendering of animated objects into a live video broadcast, all at a very low cost. One embodiment of the present invention allows for one or more users to control, move, and modify each element of a three-dimensional computer graphic in real-time or near real-time in accordance with (or in reaction to) a live event/audience, at a desirable price/performance ratio.

Among the possible uses of the present invention are uses in connection with live events, such as sporting events, music shows, or educational programs. For example, the invention may reproduce a sports play in three-dimensional format and allow a user to view such reproduction from different vantage points while it is being replayed; animating a stadium or arena during a sportscast and inserting three-dimensional athletes into broadcast images for introductions or demonstrations. Using the input(s) of a live audience to guide the three-dimensional objects and characters in real-time or near real-time, in a competition or learning situation; or weighting the inputs of a remote audience to influence three-dimensional objects and characters is a possible implementation of one or more embodiments.

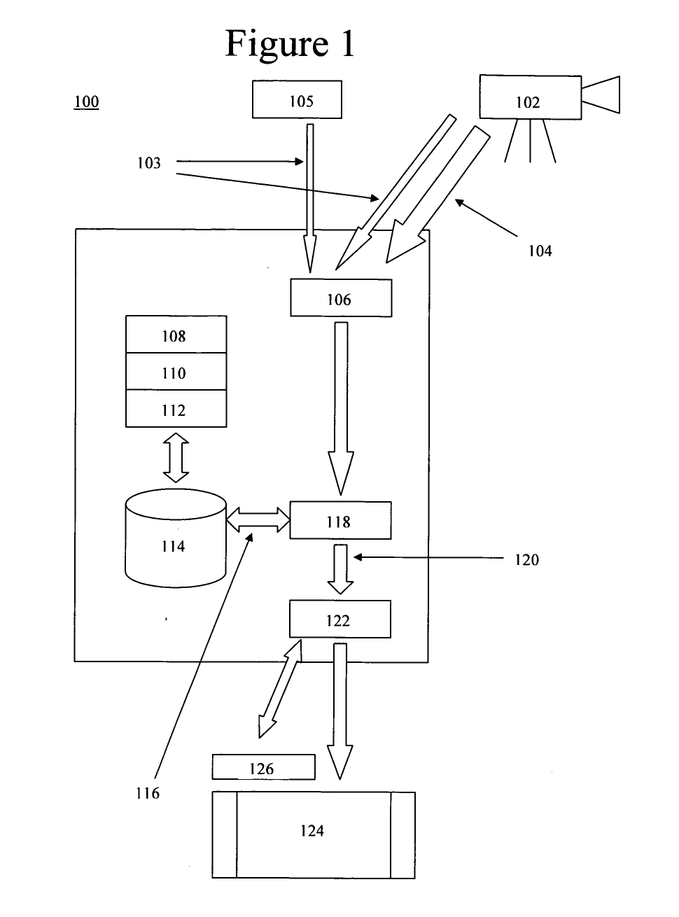

Referring to FIG. 1, the present invention may include a combination of hardware and software, such as, for example, a customizable commercially available game software engine along with other software that allows an operator to control animated three-dimensional objects in real-time or near real-time using input hardware such as a keyboard, a joystick, or any other suitable controller. The exemplary system 100 may have a camera 102 or video storage device for providing a first video signal 104. The first video signal 104 is received by a processor 106 that prepares the first video signal 104. The processor 106 may also gather perspective data 103 from the camera 102 or other device 105.

A software gaming engine uses one or more of 1)real-time inputs from one or more users 108, 2)artificial intelligence 110, 3) the laws of physics, and/or 4)real-time inputs from one or more users and artificial intelligence 112 to render a three-dimensional image. A memory device 114 stores the three-dimensional object such as a memory frame buffer located on a commercially available graphics card. A converter may also be used to convert the three-dimensional objects into an analog or digital video signal 116 suitable for broadcasting.

An alphakey, lumakey, or chromakey generator device 118 may also be used to merge the live broadcast feed with the user-generated three-dimensional objects feed. It should also be noted that data provided from sensors on a camera or other device located at the live event may be used to dynamically match the perspective of the user-generated feed with the live feed. Further, a combination of software and hardware for performing image or pattern recognition on the processing means may also be used to dynamically match the perspective of such feeds. The output of such components may be a broadcast-quality TV feed with three-dimensional objects that react to and interact with a host/narrator in a synchronous or asynchronous fashion. The invention may also be used to output visual, textual, and sound information in a synchronous or asynchronous fashion with the live broadcast. The broadcast-quality TV feed 120 may be sent to a transmitter 122 to be broadcast to one or more receivers 124 or set-top boxes 126.

The invention embodies systems and methods for allowing user interaction with a live television broadcast using real-time or near real-time rendering of three-dimensional graphics. The system contemplates three-dimensional objects that may be incorporated within, overlaid on, or transmitted separately with a live television broadcast. The three-dimensional objects may be capable of reacting to and/or interacting with text, motions, commands, signals, and/or other data transmitted with or separately from, or embedded within, a live television broadcast in a synchronous or asynchronous fashion.

Architecturally, aspects of the invention can be located on a server, workstation, minicomputer, mainframe, or any other suitable platform. Aspects of the invention may also be located on an endpoint processing device of the video network, for example a set-top box processor may perform some aspects of the user interaction and video signal processing associated with the invention.

A general purpose computer, in terms of hardware architecture, includes a processor, memory, and one or more input and/or output (I/O) devices (or peripherals) that are communicatively coupled via a local interface. The local interface can be, for example, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the components of a network. The systems and methods may be hardwired or wirelessly connected with the computer or other suitable device to perform various aspects of the invention.

The systems and methods may also be incorporated in software used with a computer or other suitable operating device, for example, one embodiment may incorporate the alphakey, chromakey and/or lumakey generator devices with the gaming software. The software stored or loaded in the memory may include one or more separate programs, each of which comprises an ordered listing of executable instructions for implementing the methods and systems of the invention. The software may work in conjunction with an operating system. The operating system essentially controls the execution of the computer programs, such as the software stored within the memory, and provides scheduling, input-output control, file and data management, memory management, and communication control and related services.

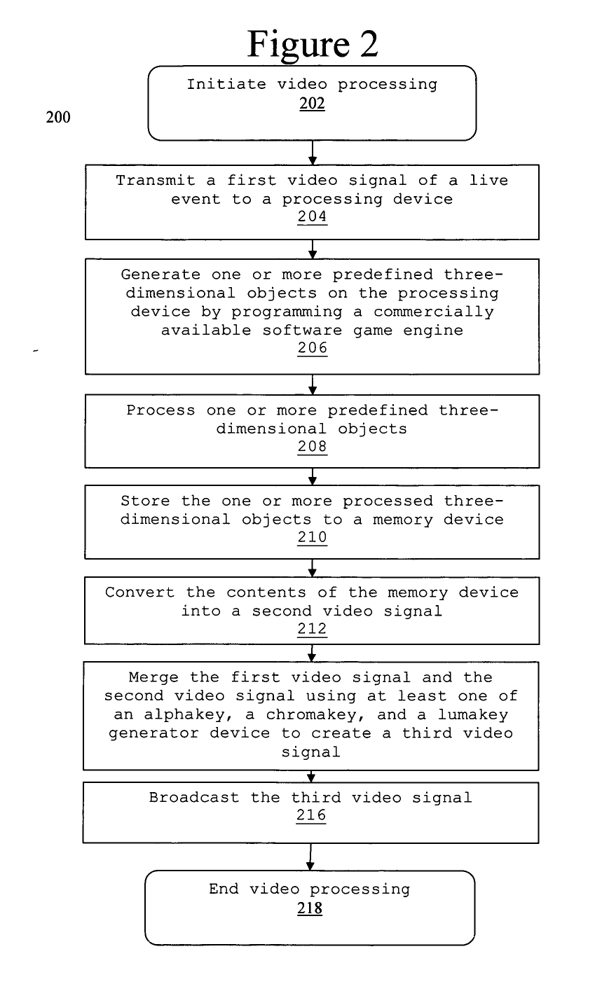

Referring to FIG. 2, the video processing is initiated by a producer or end user of the system (block 202). The method transmits a first video signal of a live event to a processing device (block 204). The method may generate one or more predefined three-dimensional objects on the processing device by programming a commercially available software game engine (block 206). The method processes one or more predefined three-dimensional objects (block 208). The method may store the one or more processed three-dimensional objects to a memory device (block 210). The contents of the memory device are converted into a second video signal (block 212). The first video signal and the second video signal may be merged using an alphakey, a chromakey, or a lumakey generator device to create a third video signal (block 214). The third video signal is broadcast to the final user (block 216). The video processing method is complete (block 218).

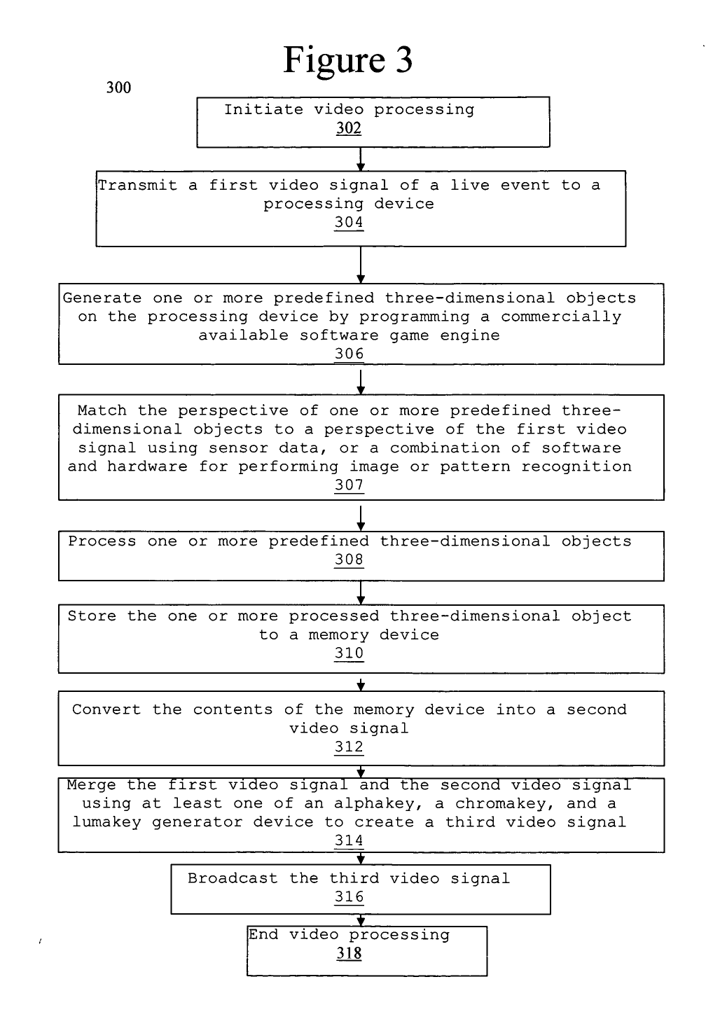

Referring to FIG. 3, the video processing is initiated by a producer or end user of the system (block 302). The method transmits a first video signal of a live event to a processing device (block 304). The method may generate one or more predefined three-dimensional objects on the processing device by programming a commercially available software game engine (block 306). The perspective of one or more predefined three-dimensional objects is matched to a perspective of the first video signal using sensor data (block 307).The method processes one or more predefined three-dimensional objects (block 308). The method may store the one or more processed three-dimensional objects to a memory device (block 310). The contents of the memory device are converted into a second video signal (block 312). The first video signal and the second video signal may be merged using an alphakey, a chromakey, or a lumakey generator device to create a third video signal (block 314). The third video signal is broadcast to the final user (block 316). The video processing method is complete (block 318).

The present invention can be practiced by other than the described embodiments, which are presented for purposes of illustration rather than of limitation and that the present invention is limited only by the claims that follow.

What is claimed is:

1. A method for incorporating three-dimensional objects into a real-time video feed, the method comprising:
Transmitting a first video signal of a live event to a processing means;
Receiving the first video signal at the processing means;
Generating one or more predefined three-dimensional objects on the processing means by programming a commercially available software game engine;
Processing one or more predefined three-dimensional objects, wherein the one or more predefined three-dimensional objects are altered dynamically and controlled using one of 1) real-time inputs from one or more users, 2) artificial intelligence, and 3) real-time inputs from one or more users and artificial intelligence;
Storing the one or more processed three-dimensional object to a memory device;
Converting the contents of the memory device into a second video signal;
Merging the first video signal and the second video signal using at least one of an alphakey, a chromakey, and a lumakey generator device to create a third video signal; and
Broadcasting the third video signal.

2. The method of claim 1, 4, 5, and 6 wherein the plurality of three-dimensional predefined objects is programmatically controlled to interact with one another in a manner that obeys the law of physics.

3. The method of claim 1, 4, 5, and 6, wherein the memory device is a graphics buffer located on a commercially available graphics card.

4. A method for incorporating three-dimensional objects into a real-time video feed, the method comprising:
Transmitting a first video signal of a live event to a processing means;
Receiving the first video signal at the processing means;
Generating one or more predefined three-dimensional objects on the processing means by programming a commercially available software game engine;
Matching the perspective of the one or more predefined three-dimensional objects to the perspective of the first video signal at a specific camera angle using software on the processing means;
Processing one or more predefined three-dimensional objects wherein the one or more predefined three-dimensional objects are altered dynamically and controlled using one or more of 1) real-time inputs from one or more users 2) artificial intelligence, and 3) real-time inputs from one or more users and artificial intelligence;
Storing the one or more processed three-dimensional objects to a memory device;
Converting the contents of the memory device into a second video signal;
Merging the first video signal and the second video signal using at least one of a chromakey and a lumakey generator device to create a third video signal; and
Broadcasting the third video signal.

5. A method for incorporating three-dimensional objects into a real-time video feed, the method comprising:
Transmitting a first video signal of a live event and sensor data to a processing means;
Receiving the first video signal and the sensor data at the processing means;
Generating one or more predefined three-dimensional objects on the processing means by programming a commercially available software game engine;
Dynamically matching a perspective of one or more predefined three dimensional objects to a perspective of the first video signal using sensor data generated at the live event;
Processing one or more predefined three-dimensional objects, wherein the one or more predefined three-dimensional objects are altered dynamically and controlled using one or more of 1) real-time inputs from one or more users 2) artificial intelligence, and 3) real-time inputs from one or more users and artificial intelligence;
Storing the one or more processed three-dimensional objects to a memory device;
Converting the contents of the memory device into a second video signal;
Merging the first video signal and the second video signal using at least one of a chromakey and a lumakey device to create a third video signal; and
Broadcasting the third video signal.

6. A method for incorporating three-dimensional objects into a real-time video feed, the method comprising:
Transmitting a first video signal of a live event to a processing means;
Receiving the first video signal at the processing means;
Generating one or more predefined three-dimensional objects on the processing means by programming a commercially available software game engine;
Dynamically matching a perspective of one or more predefined three dimensional objects to a perspective of the first video signal using a combination of software and hardware for performing image or pattern recognition on the processing means;
Processing one or more predefined three-dimensional objects, wherein the one or more predefined three-dimensional objects are altered dynamically and controlled using one or more of 1) real-time inputs from one or more users, 2) artificial intelligence, and 3) real-time inputs from one or more users and artificial intelligence;
Storing the one or more processed three-dimensional objects to a memory device;
Converting the contents of the memory device into a second video signal;
Merging the first video signal and the second video signal using at least one of a chromakey and a lumakey device to create a third video signal; and
Broadcasting the third video signal.

7. A system for incorporating three-dimensional objects into a real-time video feed, the system comprising:
A camera for capturing the live event and creating a first video signal;
A transmitter for transmitting the first video signal;
A processing means for receiving the first video signal;
A commercially available customizable software game engine located on the processing means for generating one or more predefined three-dimensional objects, wherein the one or more predefined three-dimensional objects are altered dynamically and controlled using one or more of 1) real-time inputs from one or more users, 2) artificial intelligence, and 3) real-time inputs from one or more users and artificial intelligence;
A memory device located on the processing means capable of storing one or more predefined three-dimensional objects
A converter for creating a second video signal that includes the contents of the memory device;
A merging means for merging the first video signal and the second video signal and creating a third video signal; and
A transmitter for broadcasting the third video signal.

8. The system of claim 7, wherein the memory device is a graphics buffer located on a commercially available graphics card.

9. The system of claim 7, wherein the merging means is one of an alphakey, a chromakey, and a lumakey generator device.

10. A system for incorporating three-dimensional objects into a real-time video feed, the system comprising:
A camera for capturing the live event and creating a first video signal;
A transmitter for transmitting the first video signal;
A processing means for receiving the first video signal;
A commercially available customizable software game engine located on the processing means for generating one or more predefined three-dimensional objects, wherein the one or more predefined three-dimensional objects are altered dynamically and controlled using one or more of 1) real-time inputs from one or more users, 2) artificial intelligence, and 3) real-time inputs from one or more users and artificial intelligence;
A matching means for matching a perspective of one or more predefined three dimensional objects to a perspective of the first video signal;
A memory device located on the processing means capable of storing one or more predefined three-dimensional objects;
A converter for creating a second video signal that includes the contents of the memory device;
A merging means for merging the first video signal and the second video signal and creating a third video signal; and
A transmitter for broadcasting the third video signal.

11. The system of claim 10, wherein the memory device is a graphics buffer located on a commercially available graphics card.

12. The system of claim 10, wherein the merging means is one of an alphakey, a chromakey, and a lumakey generator device.

13. The system of claim 10, wherein the matching means is a software program that matches a perspective of one or more predefined three-dimensional objects to a perspective of the first video signal at a specific camera position.

14. A system for incorporating three-dimensional objects into a real-time video feed, the system comprising:
A camera for capturing a live event creating a first video signal;
One or more sensors for producing sensor data that determine the camera angle;
A transmitter for transmitting the first video signal and the sensor data;
A processing means for receiving the first video signal and the sensor data;
A commercially available customizable software game engine;
A processing means for generating one or more predefined three-dimensional objects, wherein the one or more predefined three-dimensional objects are altered dynamically and controlled using one or more of 1) real-time inputs from one or more users, 2) artificial intelligence, and 3) real-time inputs from one or more users and artificial intelligence;
A matching means for dynamically matching a perspective of the one or more predefined three-dimensional objects to a perspective of the first video signal using sensor data generated at the live event;
A memory device located on the processing means capable of storing one or more predefined three-dimensional objects;
A converter for creating a second video signal that includes the contents of the memory device;
A merging means for merging the first video signal and the second video signal and creating a third video signal; and
A transmitter for broadcasting the third video signal.

15. The system of claim 14 wherein the memory device is a graphics buffer located on a commercially available graphics card.

16. The system of claim 14, wherein the merging means is one of an alphakey, a chromakey, and a lumakey generator device.

17. The system of claim 14, wherein the matching means is at least one of a software program, a hardware device, and a combination of software and hardware located on the
processing means that dynamically matches a perspective of one or more predefined three-dimensional objects to a perspective of the first video signal;

18. A system for incorporating three-dimensional objects into a real-time video feed, the system comprising:
A camera for capturing a live event and creating a first video signal;
A transmitter for transmitting the first video signal;
A processing means for receiving the first video signal;
A commercially available customizable software game engine located on the processing means for generating one or more predefined three-dimensional objects, wherein the one or more predefined three-dimensional objects are altered dynamically and controlled using one or more of 1) real-time inputs from one or more users, 2) artificial intelligence, and 3) real-time inputs from one or more users and artificil intelligence;
A matching means for dynamically matching a perspective of the one or more predefined three-dimensional objects to a perspective of the first video signal using image or pattern recognition software and hardware;
A memory device located on the processing means capable of storing one or more predefined three-dimensional objects;
A converter for creating a second video signal that includes the contents of the memory device;
A merging means for merging the first video signal and the second video signal and creating a third video signal; and
A transmitter for broadcasting the third video signal.

19. The system of claim 18 wherein the memory device is a graphics buffer located on a commercially available graphics card.

20. The system of claim 18, wherein the merging means is one of an alphakey, a chromakey, and a lumakey generator device.

21. The system of claim 18, wherein the matching means is at least one of a software program, a hardware device, and a combination of software and hardware located on the processing means that dynamically matches the perspective of the one or more predefined three-dimensional objects to the perspective of the first video signal.
